(19) United States
(12) Patent Application Publication
(10) Pub. No.: US 2009/0295789 A1
(43) Pub. Date: Dec. 3, 2009

(54) Methods for Dynamically Displaying Digital Images on Digital Display Devices

(75) Inventors: Ting Yao, San Jose, CA (US); Xuyun Chen, San Jose, CA (US); Jiping Zhu, San Jose, CA (US); Michael Yip, Los Altos, CA (US)

Correspondence Address: Venture Pacific Law, PC, 5201 Great America Parkway, Suite 270, Santa Clara, CA, 95054, US

(73) Assignee: Amlogic, Inc., Santa Clara, CA (US)

(21) Appl. No.: 12/132,586

(22) Filed: Jun. 3, 2008

(51) Int. Cl. G06F 17/00

(52) U.S. Cl. 345/418

(57) ABSTRACT

The present invention relates to methods for dynamically displaying images on a display window of a digital display device such as a digital picture frame. These methods include the steps of: processing the source image into a canvas image having canvas pixels as a function of the source image characteristics; upon the canvas image meeting one or more conditions for the panning of an image, selecting a panning velocity for the canvas image; defining a viewing window with respect to the canvas image wherein said viewing window having a viewing image, said viewing image is to have a plurality of viewing pixels; calculating the viewing pixels for said viewing image; displaying said viewing image for said viewing window on said display window; redefining said viewing window with respect to the canvas image as a function of said panning velocity; and repeating the calculating and displaying steps for said viewing window. These methods allow for the dynamic display of images with special effects on a digital display device as a function of the properties of the image (e.g. a panoramic image). They also provide for the smooth panning of digital images at velocities that are accurate up to fractional pixels per unit time.

### FIELD OF INVENTION

This invention relates to methods for displaying of images, and in particular, to methods for displaying images having certain characteristics (e.g. a panoramic image) on digital display devices such as digital picture frames.

### BACKGROUND

Digital display devices (“DDDs”) such as digital picture frames (“DPFs”) allow the digital display of a collection of photos or images. The advancement in the mass production of LCDs resulted in the lowering of the cost of the LCDs and therefore of the DDDs as well. As DDDs become more and more popular, particular problems associated with DDDs are becoming apparent and require customized solution. There are several factors to consider with respect to DDDs, for example image quality, ease of setup, ease of use, and image presentation.

Ideally, DDDs should be able to accept source images from a variety of capture devices or external images. These source images may also have a variety of properties such as having a variety of heights, widths, aspect ratios, and resolutions. When the properties of the source image do not conform with the properties of the DDD such as the size of a display window, the DDD needs to have the capability of processing the source image and displaying the resulting digital image. For example, if the provided image has an image size of 1024×768 pixels and the particular DDD has a display window size of 720×480 pixels, the provided image need to be resized before it can be properly displayed on the display window of the DDD. At present, most DDDs only allow for the limited processing of the original image. They may be able to reduce the resolution of the original image to conform to the resolution of the DDD. They may also be able to perform limited resizing by reducing the size of the image such that the entire source image fits into the display window of the DDD, or in the alternative, crop the original digital image such the only a portion of the source image is displayed.

However, these types of resizing methods do not allow the DDD to display the digital image adequately. For example, FIG. 1 illustrates a panoramic image that may be formed with a digital camera where side-by-side images of a panoramic view are taken and are stitched together to form the larger image. The width of this type of images is often much greater than its height (or, for a vertical scenery, the height is much longer than its width). These types of source images cannot be displayed satisfactorily with the traditional resizing capability of the DDDs. FIG. 2a illustrates the resulting image produced by some of the resizing methods of the prior art. In order to fit the width of the entire source image into the width of the display window, the entire image has to be decreased significantly such that most of the display window is not used, where the height of the reduced image is much less than the height of the display window. Many details of this reduced source image are not adequately displayed in this reduced format.

FIG. 2b illustrates a second type of resizing method of the prior art. In this type of resizing methods, only a small portion of the image is displayed. Again, this type of resizing methods is unsatisfactory because the display fails to properly display the effect of panoramic view of the source image.

Therefore, it is desirable to provide methods for displaying digital images on the display window of a DDD that would take into account the special properties of a digital image.

### SUMMARY OF INVENTION

An object of this invention is to provide methods for dynamically displaying digital images having special characteristics with special effects on a digital display device.

Another object of this invention is to provide methods for automatically adjusting the mode of display of a digital image as a function of the properties of that digital image.

Another object of this invention is to provide methods for the smooth panning of a digital image at velocities that are accurate up to fractional pixels per unit time.

Another object of this invention is to enable the viewing of images of unlimited sizes and resolutions on digital display devices with display windows that are limited in size and resolution.

The present invention relates to methods for dynamically displaying a source image on a display window of a digital display device, wherein the source image having source image characteristics, comprising the steps of: processing the source image into a canvas image having canvas pixels as a function of the source image characteristics; upon the canvas image meeting one or more conditions for the panning of an image, selecting a panning velocity for the canvas image; defining a viewing window with respect to the canvas image wherein said viewing window having a viewing image, said viewing image is to have a plurality of viewing pixels; calculating the viewing pixels for said viewing image; displaying said viewing image for said viewing window on said display window; redefining said viewing window with respect to the canvas image as a function of said panning velocity; and repeating the calculating and displaying steps for said viewing window.

An advantage of the methods of this invention is that they can dynamically display digital images having special characteristics with special effects on a digital display device.

Another advantage of the methods of this invention is that they can automatically adjust the mode of display of a digital image as a function of the properties of that digital image.

Another advantage of the methods of this invention is to provide for the smooth panning of digital images at velocities that is fractional pixels per unit time.

Another advantage of the methods of this invention is that they enable the viewing of images of unlimited sizes and resolutions on a digital display device with a display window that is limited in size and resolution.

### DESCRIPTION OF DRAWINGS

The foregoing and other objects, aspects and advantages of the invention will be better understood from the following detailed description of preferred embodiments of this invention when taken in conjunction with the accompanying drawings in which:

FIG. 1 illustrates a panoramic image that may be properly displayed using the methods of this invention.

FIG. 2a is an illustration of a prior art method for displaying the panoramic image of FIG. 1.

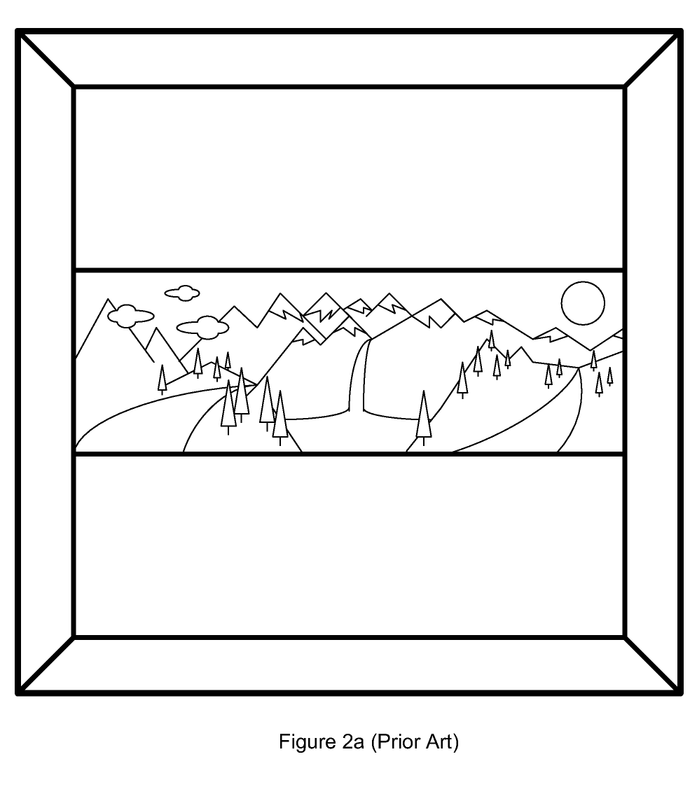

FIG. 2b is an illustration another prior art method for displaying the panoramic image of FIG. 1.

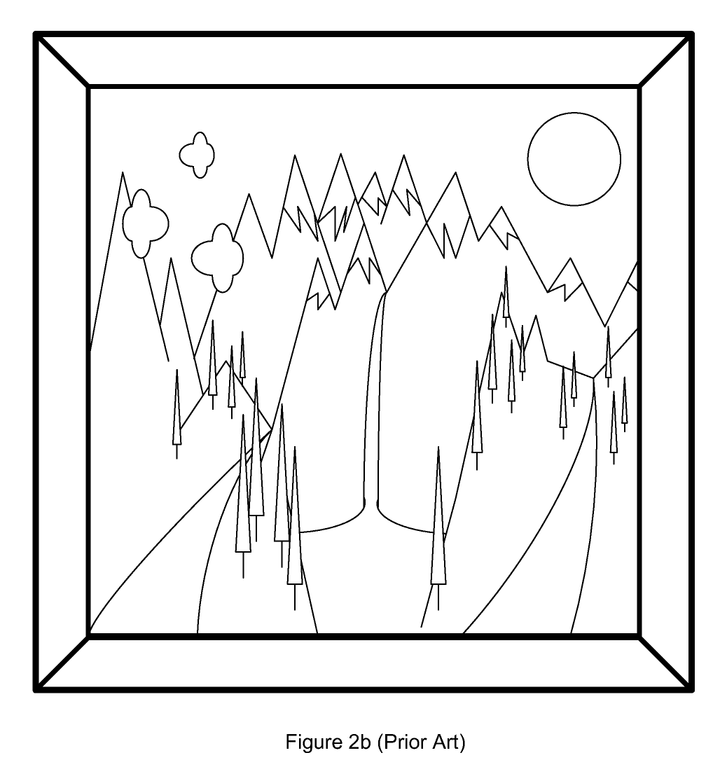

FIGS. 3a through 3e illustrate the moving of the viewing window for displaying the image of FIG. 1 using methods of this invention.

FIGS. 4a through 4e illustrate the images as selected by the viewing windows (as illustrated by FIGS. 3a through 3e) during the different time periods over the canvas using the methods of this invention.

FIGS. 5a through 5e illustrate the image displayed by the display window of the digital display device during the different time periods using the methods of this invention.

FIGS. 6a through 6f illustrate the panning of an image using a method of this invention.

FIG. 7 illustrates a flowchart for a preferred method of the present invention.

FIGS. 8a-8b illustrate the moving of the viewing pixels by a pixel unit.

FIGS. 9a-9b illustrate the moving of fractional viewing pixels to a position that does not coincide with a canvas pixels.

FIGS. 10a-10b illustrate the positions and canvas pixels on a canvas that may be used to calculate the viewing image characteristics at position (a,b).

### DETAILED DESCRIPTION OF THE PREFERRED EMBODIMENTS

The presently preferred methods of the present invention provide methods for displaying an image as a function of the properties of that image and for a particular digital display device (such as a digital picture frame).

### Terminology Used

In the discussions herein, the following terminology may be used, and it shall be understood that the methods and embodiments of the present invention are not to be limited by the definition of the terminology provided below:

Source image. The image obtained from a source. Sources may include a capturing device such as a camera or a storage device.

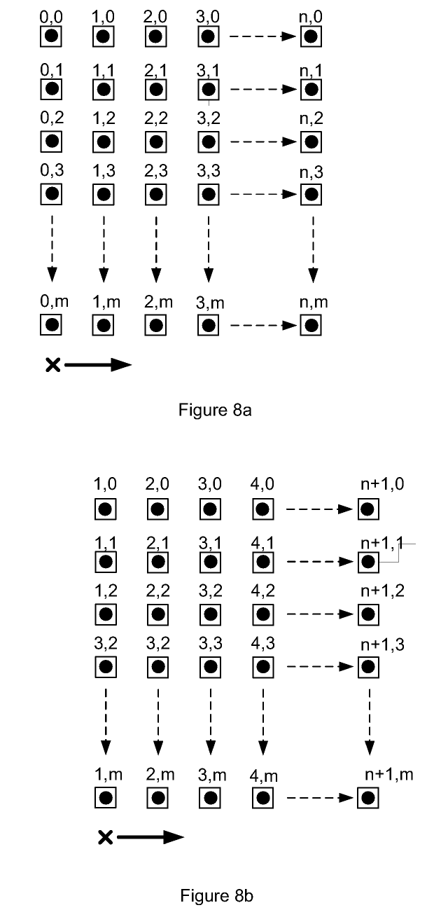

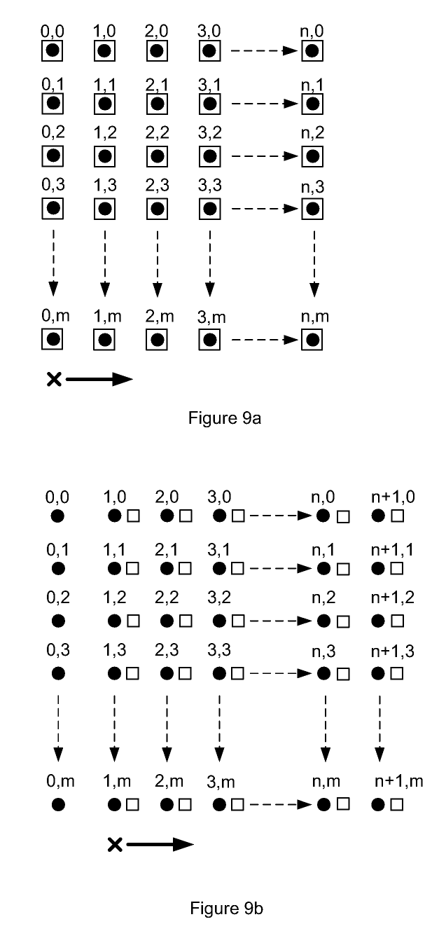

Canvas and canvas image. The canvas image is the image obtained after the source image has been prepared for use in a DDD. The canvas image is defined by the canvas pixels. The canvas image characteristics between the canvas pixels, herein referred to as canvas positions, are virtual positions that can be defined. FIG. 8a is a representation of a canvas having n rows in the “y” (second) dimension and m columns of pixels in the “x” (first) dimension that are represented by the dark circles. The location of each pixel maybe characterized by two integers, depicting the x and y position of that pixel. The point “a” in FIG. 9b is not on any canvas pixels and therefore is a virtual canvas position; the image characteristics of the canvas at position “a” is not given and would need to be calculated (if so desired).

Canvas properties. Any parameter relating to the canvas or canvas image is a canvas property. Examples of canvas properties may be the width, height, or aspect ratio of the canvas, or the characteristics of the canvas image.

Viewing window. A viewing window is a portion of the canvas that is to be displayed by the display window at any one time during panning. The characteristics of the viewing image within the viewing window are defined by a set of viewing pixels. Depending on the location of the viewing window, the viewing pixels may or may not to be calculated. A viewing pixel is illustrated in the drawings described herein as a small rectangle. (□)

Viewing properties. Any parameter relating to the viewing window is a viewing property. Examples of viewing properties may be the width, height, or aspect ratio of the viewing window, or the characteristics of the viewing image within the viewing window.

Pij. The characteristics of a pixel of an image, either a canvas image or a viewing image, is represented as Pij where i and j refers to the position of the pixel in the image. For example, P00 may refers to the image characteristic at the pixel (0,0) while Pab refers to the image characteristics at position (a,b).

Display window. A display window may be the window of the DDD that displays a display image as defined by a viewing widow.

Display properties. Display properties may be any parameter relating to the display window including but nor limited to the height and width of the display window.

“x” dimension. The dimension that defines the width of the image, also referred to herein as the first dimension.

“y” dimension. The dimension that defined the height of the image, also referred to herein as the second dimension.

Panning. Panning may mean the moving of the viewing window having a viewing image at panning velocity.

In a presently preferred method of the present invention, a first step is to determine the conditions that trigger panning of an image. With pre-determined conditions, the DDD may be programmed such that panning automatically occurs once these conditions are triggered. The conditions for triggering panning may differ. In one preferred method, all images are to be panned. In another preferred method, the conditions for panning may depend on the size, aspect ratio, height or width of the canvas and the display window. (In the discussions herein, the term aspect ratio is used in the same manner as is commonly used in the field of image processing or display.) For example, if the horizontal dimension (the first dimension) is the dimension for the width of the canvas or the width of the display window, one criteria for triggering panning in the horizontal direction may be that the aspect ratio of the canvas divided by the aspect ratio of the display window is greater than 2. Similarly, if the vertical dimension (the second dimension) is the dimension for the height of the canvas, the criteria for the triggering of the panning in the vertical direction may be that the aspect ratio of the canvas divided by the aspect ratio of the display window is less than one-half (½).

The preparing of the source image to form the canvas image may include one or more of the following: obtaining or downloading the source image from a capture device or external storage; obtaining the properties of the source image, such as its width, height, aspect ratio, width/height, or height/width; decoding, if necessary, the source image into an internal format that the DDD may use; decoding, if necessary, a high resolution image to a lower resolution image in order to reduce the storage size; resizing the image; storing information relating to the decoded image and the source image in the buffer memory of the DDD. The decoded image is referred to as the canvas image and may be stored in the buffer. In preferred embodiments, this canvas may have the same aspect ratio as the source image. For example, if the source image is a 100×1000 (JPEG/BMP), after decoding and preparation, the canvas can be a 50×500 image having the internal format of the DDD.

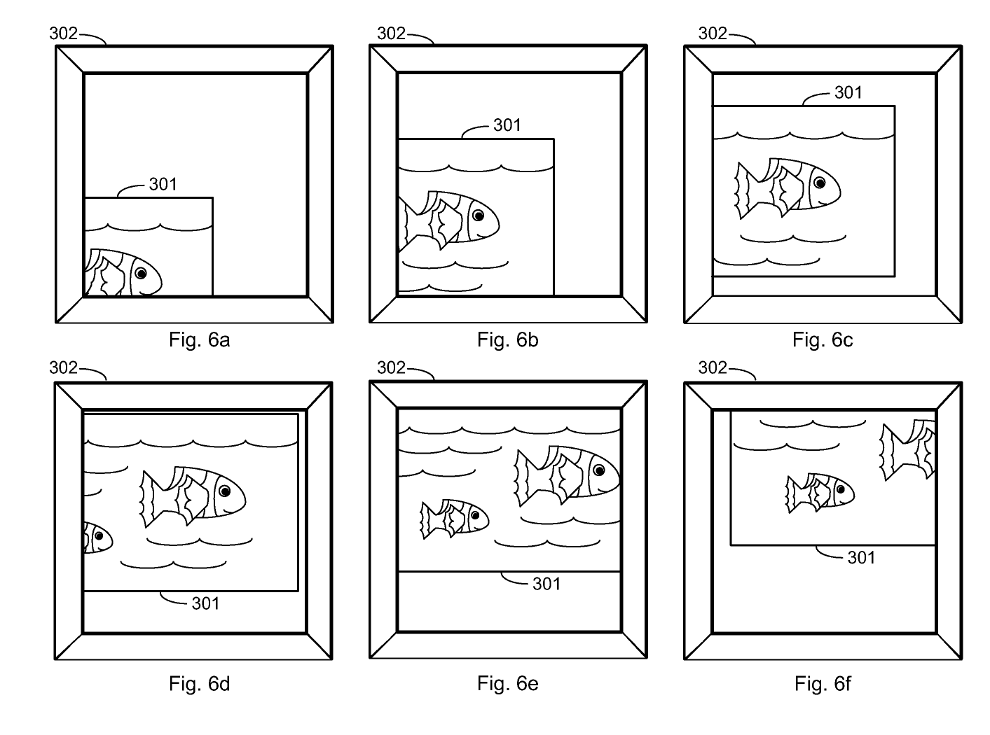

After preparation and selection of a particular canvas image to display, the selected canvas image is then examined in order to decide if it meets one or more of the conditions for panning. If the image is not to be panned, then the display of the image may follow the traditional methods for statically display of a digital image. The canvas image may be processed for static display. This processing may involve resizing the canvas such that the entire or selected portions of the canvas are displayed in the display window. FIGS. 6a though 6f illustrate a preferred method for panning where the velocity of panning may be two dimensional.

If the image is determined to be dynamically displayed, then the velocity of panning, i.e., the direction of the panning as well as the speed of the panning, need to be determined. The panning velocity may be a function of many parameters, including canvas properties, display properties, viewing properties, and time. For example, the panning velocity may be a sinusoidal function of time. It may also depend on the position of the viewing image on the display window. For example, the panning velocity may be slower if only one part of the viewing image is displayed and the panning velocity may be increased as the area of the viewing image displayed is increased.

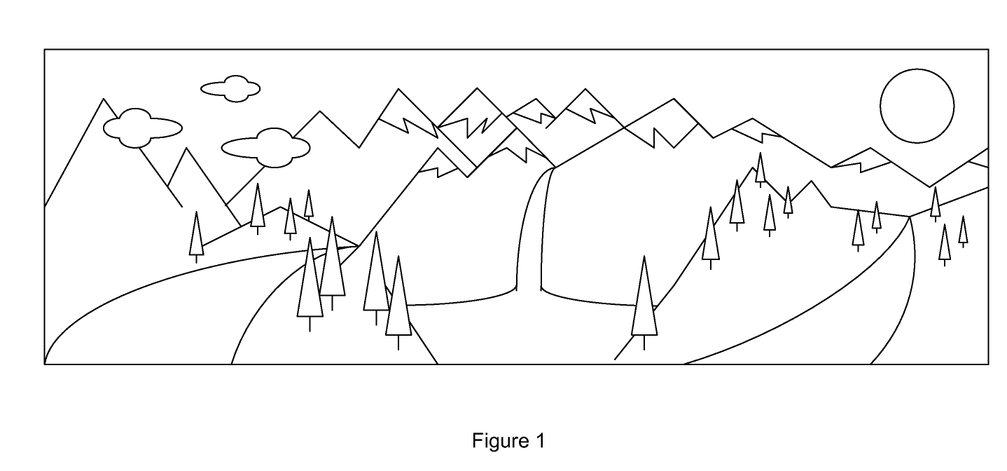

In another example, the direction of panning may be determined by the height, width or aspect ratio of the canvas and the display window. For example, if the canvas image is that of a panoramic view such as that illustrated in FIG. 1 where the canvas width is much greater than its height, one preferred method for panning is to pan in the “x” dimension. The speed of the panning may be determined by the width of the canvas. It may also be determined based upon the general characteristics of the image (e.g. a portrait shot or a group shot, an indoor shot or an outdoor shot), the number of contrasting items, the number of colors, the number of identified distinct items. The panning velocity may be two dimensional; i.e., the viewing window may move both in the “x” dimension and the ‘Y’ dimension. Also, the panning velocity for an image may also vary with time, the position of the viewing window with respect to a canvas parameter or other parameters, including parameters relating to other canvas images or the display window. The panning velocity may even be generated randomly.

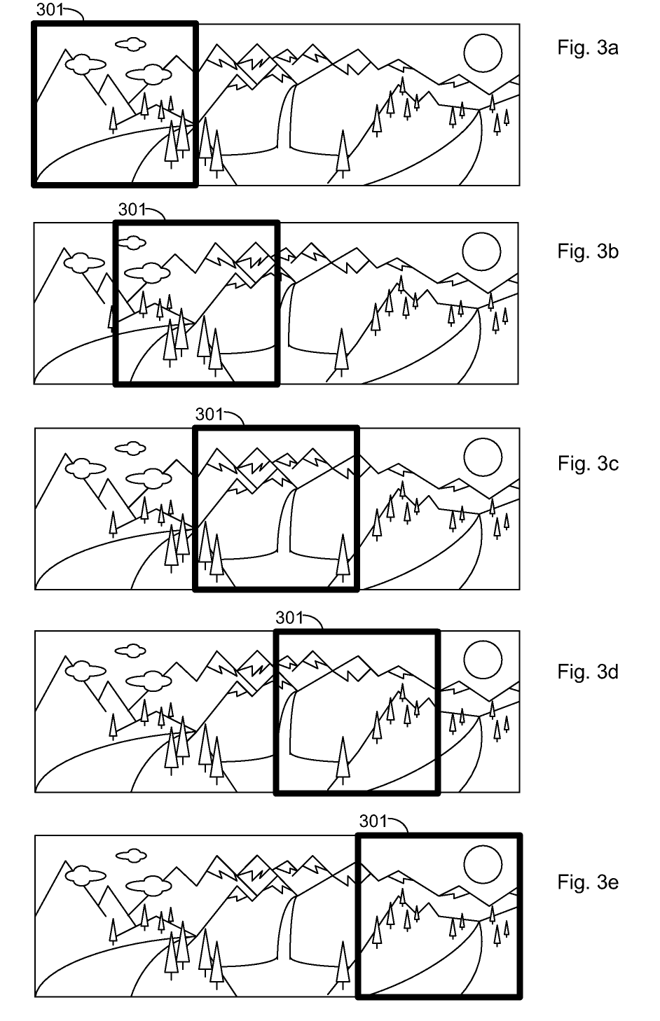

The canvas image illustrated in FIG. 1 and whose panning is illustrated in FIGS. 3a-3e is an example where the panning is in the x dimension such that effect of the panning is to sweep across the entire width of the canvas of a panoramic image. However, even with this simple example, the panning velocity does not have to be constant. For example, the panning velocity may start at a certain speed when only a small portion of the viewing window is shown but decreases its speed as more and more of the viewing window is displayed such that a viewer has more time to look at or examine the display.

As described above, the panning velocity may be dependent of the size of the canvas image, viewing image or display window. It may even be dependent on the properties of the viewing image that is currently being displayed in the display window. For example, the panning velocity may be inversely proportional to the brightness of an image or a portion of an image that is currently on display such that the panning velocity is reduced and the image moves slower across the display window when an image is brighter.

However, in other preferred embodiments, the panning velocity and speed may be nonlinear and/or object based. The panning velocity may be object based when it depends on the properties of an object or a number of objects within the viewing image (“objects”) that are being displayed in the display window. The panning velocity is nonlinear when it varies during panning of an image. When this variation is dependent on objects, then, the panning velocity is non-linear and is object based. For example, the panning velocity may be reduced when faces in a panoramic school graduation picture are being displayed while the panning velocity may be increased when the buildings within that picture are being displayed.

The different modes of presentation created by panning or moving an image at a variable velocity may be infinite, limited only by the creativity of the DDD maker. As another example, a digital image that is not a panoramic image and that can fit into a part of the display can be panned at a two-dimensional velocity for presentational effect such that it may look as if it is slowly entering the display window from the edge of the display window, floats around the window for a while, and then leave the display window at some other edge. In this example, the panning velocity may be set to be time dependent or dependent on the position of the viewing image on the display screen. An example of such a display is illustrated by FIGS. 6a through 6f.

Another method of display may have an image slowly entering the display window as the previous image is slowly leaving the display window from some other location of the display window. The panning velocity of this method of display may not only be time dependent but may also depend on the panning velocity of the previous image and the position of the previous image on the canvas.

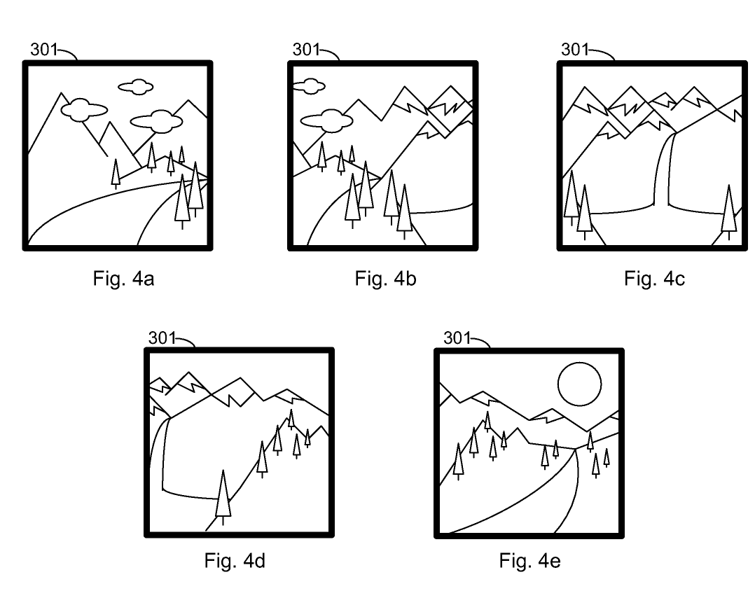

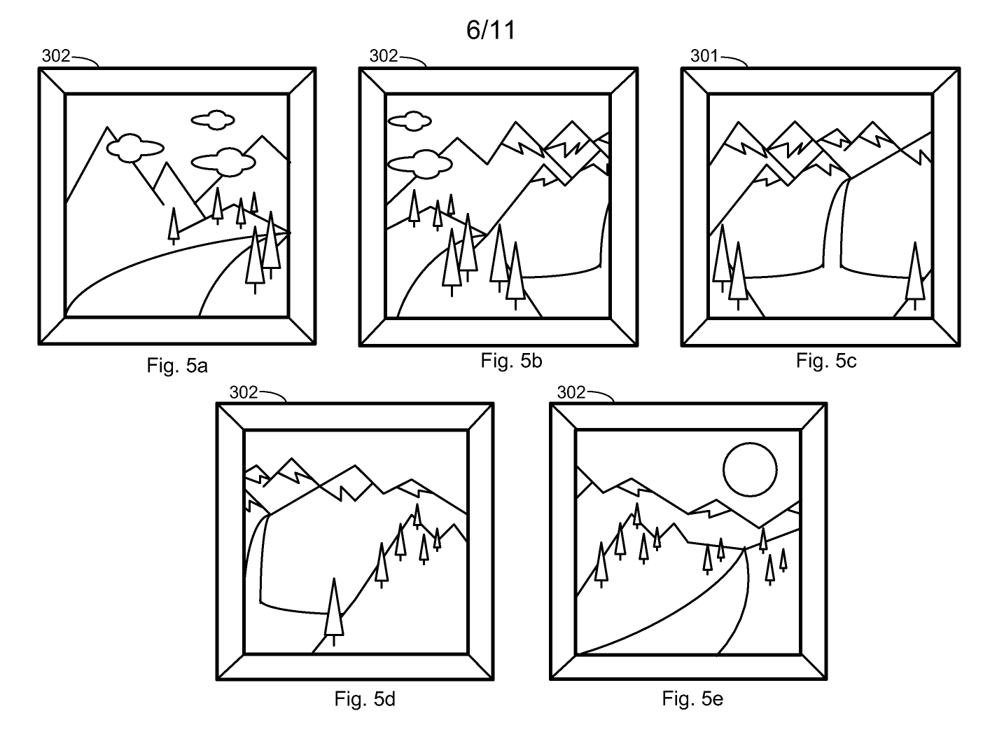

The viewing window is a portion of the canvas and formed by selecting a portion of the canvas as the viewing window. The size of the viewing window may depend on multiple factors such as the height or width of the canvas and/or the panning speed. In one preferred method, the viewing window is cropped such that it has the same aspect ratio as the display window. Another preferred method is to display an image such that the image is maximized for display on the display window at any one time. To do so, given a panning velocity, the viewing window may be selected such that the dimension of the image that is not being panned is maximized for display. For example, if the image is of a panoramic view such that its width is much larger than its height, the image may be panned in the x direction as indicated by FIGS. 3a through 3e. Yet another method is to set the height of the viewing window to be the height of the canvas such that, after resizing, the viewing window (301) is selected such that the display window displays the entire height of the image in its display window while the width of the image is being panned at the defined panning velocity. FIGS. 3a through 3e illustrate the movement of the viewing window as the entire canvas is being panned while FIGS. 4a through 4e illustrate the viewing window during panning. FIGS. 5a through 5e illustrate the viewing image as displayed by the display window (302).

The example illustrated by FIGS. 6a through 6e show another method for selecting the size of the viewing window for an image. Here, the viewing window is the size of the entire canvas. However, it is sized for display such that it only occupies a part of the screen but the panning velocity is set such that the image floats slowly from the top corner of the display window and leaves from the bottom corner.

With the size of the viewing window determined, the initial position to begin panning may need to be selected by selecting a particular viewing window. In a preferred embodiment, the panning starts on an edge or corner of the canvas. For example, if it is decided that the panning is to be from left to right for a panoramic image, then, in the preferred embodiment, the first viewing window may be positioned at the left end of a canvas.

Once this viewing window is selected, the characteristics of the viewing image will then have to be calculated. If the viewing pixels in this viewing window coincide with the canvas pixels, i.e., in situations where the viewing pixels of the viewing window coincide with the canvas pixels (or the panning velocity are in integer multiples of the canvas pixels per unit time), then the viewing pixels of a viewing image can be easily determined, where they may simply equal to the corresponding canvas pixels of the canvas image.

However, if the viewing pixels for a viewing image fall on virtual canvas positions (e.g. in between canvas pixels), then the viewing pixels may have to be estimated or calculated. The methods for calculating the viewing pixels are described below.

Processing of the viewing image for display may also occur, sometimes during the determination of the viewing image characteristics. Processing may involve resizing or zooming by cropping the canvas and the viewing window appropriately. After processing, this processed viewing image is then displayed by the display window.

In order to provide smooth panning of the viewing image, it may be desirable to pan at less than a whole pixel per unit time. If the panning velocity is (a, b) pixels per unit time, i.e., if the panning speed is “a” pixels (or first pixels) per unit time in the x (first) dimension and “b” pixels (or second pixels) per unit time in the y (second) dimensions, then after the defined unit of time, the viewing window may be moved “a” (first) pixels in the x dimension and “b” (second) pixels in the y dimension. The characteristics of the new viewing image corresponding to the new viewing window is calculated, the new viewing image is processed, and displayed as previously described. These steps are repeated until the panning for this image is completed.

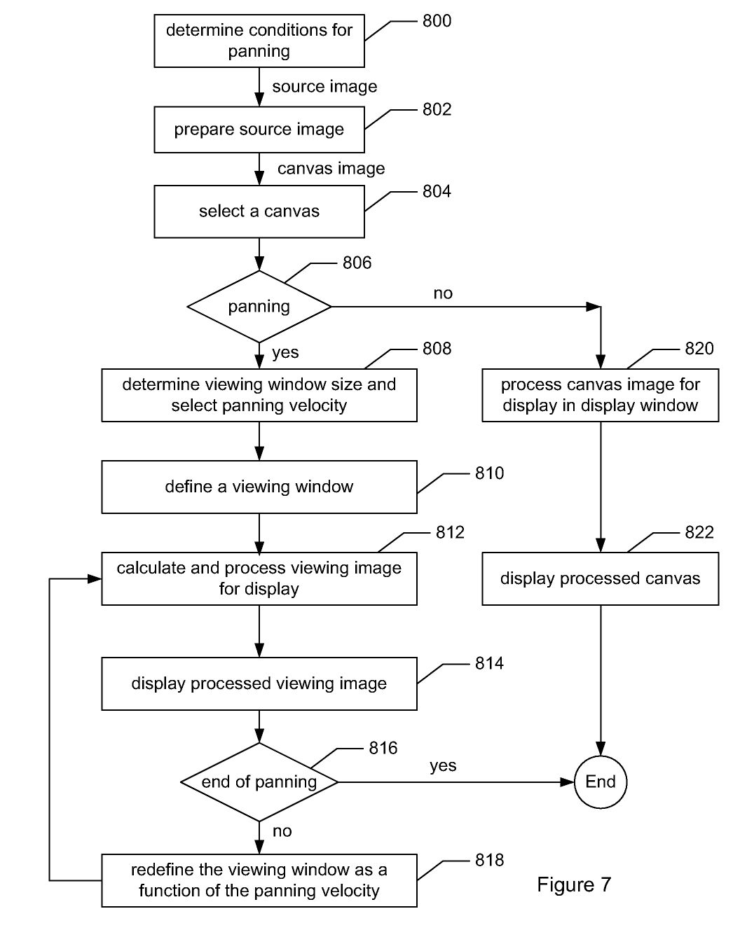

FIG. 7 illustrates a flowchart showing the general steps for a preferred method of the present invention. After determining the conditions for panning (800), the source image is prepared for that DDD (802) and converted into a canvas image. Using one or more pre-defined conditions for panning, whether this canvas image should be panned can then be decided (806). If the image is not to be panned, then it can be processed for display in the display window (820). If the canvas image is to be panned, then the panning velocity and the size of the viewing window may then be determined (808). A viewing window is selected (810) and the viewing pixels then may be calculated. In addition, the viewing image may also be processed for display and this processing may occur while the viewing image is being calculated. After the calculating and processing step(s), the viewing image is moved at a distance determined by the panning velocity; and the whole process of calculating, processing, and displaying is repeated for the canvas image until the panning for that image is completed.

### Determination of Viewing Image

One method of panning is based upon the moving of the viewing window at multiples of pixels per unit time. Thus, for example, as illustrated in FIG. 8a, if a viewing window is defined on viewing pixels (□) that coincides with a two dimensional set of canvas pixels () defined by the corner pixels (0,0), (n,0), (0,m) and (n,m), then, if the panning velocity is one pixel per unit time in the x direction, then, after a unit of time, the viewing pixels of the viewing window would be moved to the viewing pixels that coincides with the two dimensional set of canvas pixels defined by the corner pixels (1,0), (n+1,0), (1,m), (n+1,m). See FIG. 8b. Since the viewing pixels coincides with canvas pixels where the characteristics of the canvas image at the canvas pixels are defined, then, the characteristics of the viewing image at the viewing image can be simply determined to be equal to, or a function of the characteristics of the canvas image at the corresponding canvas pixels.

### Determination of Viewing Pixels

One of the advantages of the preferred methods of the present invention is that the viewing window can be moved more than just multiples of pixels; they can be moved a fractional of pixels per unit time. That is, the viewing window may be moved in fractional pixels per unit time. This added refinement in the movement of viewing window and the panning velocity allows for much smoother panning and presentation of the images. In a preferred method, the viewing window can be moved to the accuracy of 1/16^{th} or 1/64^{th} of a pixel per unit time. For example, in one preferred method, if the unit of time used for panning is 30 milliseconds the viewing image may be panned at 1/64^{th} of a pixel every 30 millisecond, that may provide a much smoother panning of the image.

FIGS. 9a and 9b illustrates the moving of a viewing windows of 1¼ pixels per unit time. In the example in FIG. 9a, the viewing window is defined on viewing pixels that coincides with a two dimensional set of canvas pixels defined by the corner canvas pixels (0,0), (n,0), (0,m) and (n,m) that are shown as black circles. If the panning velocity is 1¼ pixels per unit time in the x dimension (first dimension), then, after a unit of time, the viewing window would be moved to the viewing pixels that are on canvas positions and that does not coincides with any canvas pixels. Since the viewing pixels that are on canvas positions where the characteristics of the image is not defined, the image characteristics on these viewing pixels has to be determined or estimated based on the characteristics of the canvas image characteristics on surrounding canvas pixels.

Interpolation, either non-adaptive or adaptive interpolation algorithms, may be used for this estimation or determination. Non-adaptive algorithms that may be used include: nearest neighbor, bilinear, bicubic, spline, sinc, and lanczos methods. For example, a bicubic algorithm may assume that, in two dimensions, the surrounding 4×4 pixels may contribute to the characteristics at the viewing pixel in question. These different methods use different numbers of surrounding canvas pixels for calculating the respective viewing pixel. Depending on the quality of the image desired, these interpolation methods may use from 0 to 256 or more adjacent pixels during interpolation. The more adjacent pixels that are used, the more accurate these algorithms may be in approximating or estimating the true image characteristics. However, the more adjacent pixels that are used, the longer the processing time is required for calculating or estimating the viewing image. Therefore, as a compromise between processing time and quality of the viewing image, a preferred method here uses the bicubic method of interpolation.

Adaptive algorithms may also be used. They apply special algorithms, sometimes on a pixel-by-pixel basis when the presence or an edge is detected in order to minimize the interpolation artifacts in the regions that are most apparent.

Interpolation uses the characteristics of the canvas image at surrounding pixels to estimate the viewing image for viewing pixels that do not coincide with the canvas pixels. Different interpolation algorithms give different weight to the surrounding canvas pixels in influencing the characteristics of the viewing image. They may use different filters that put different relative weight on the surrounding pixels for use to calculated to the viewing image characteristics. Filters that can be used may include the box, tent, Gaussian, catmull-rom and sinc. Preferred method uses a tent or triangular filter and a catmull-rom filter.

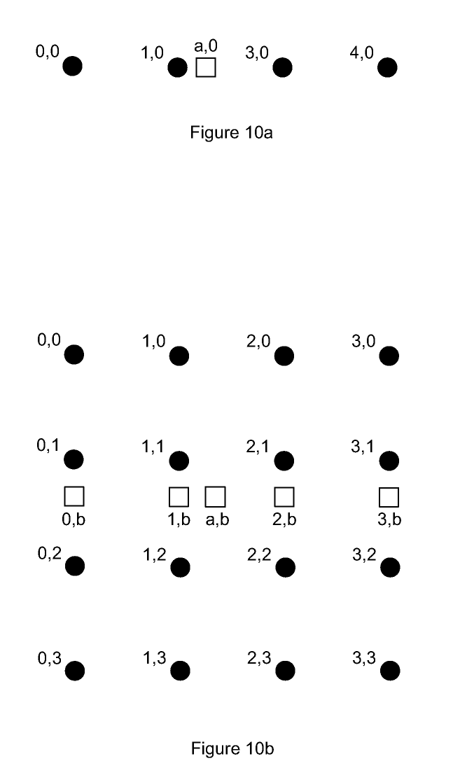

For example, in a one dimensional bicubic estimation, i.e., an estimation that only takes into account the canvas image in one dimension such as that illustrated in FIG. 10a, the characteristics of the viewing image at the viewing pixel (a,0) is calculated as a weighted sum of the canvas image characteristics P00, P10 at the canvas pixels (0,0) and (1,0) to the left of the viewing pixel and the canvas image characteristics P20 and P30 at the canvas pixels (2,0) and canvas pixels (3,0).

The weight or influence of the characteristics of each of the pixel can vary depending on the filter chosen that may define the desired sharpness of the characteristics of the viewing image. Once the sharpness, and thus the weight of each of the canvas pixels, is determined, the coefficients, a reflection of the weight for that coefficient can then be determined and pre-calculated in a table. The viewing image characteristics P(a,0) is then a sum of the coefficients over the canvas pixels used for the respective method of interpolation where a filter that defines the sharpness of the viewing image may be selected. Different filters may be used to produce the desired effect for the transitions of the viewing images. Once the filter is selected, the coefficients, i.e., the weighing of the different surrounding pixels, can be determined, and the resulting characteristics is the sum of the surrounding pixels weighed by their coefficients.

The following illustrates how coefficients can be obtained for the example illustrated in FIG. 9a using a triangular (tent) filter where the position of the viewing pixel is specified to an accuracy of 1/64 pixel. A triangular (tent) filter F(x) may be defined as:

$$\begin{matrix}F ( x ) = & 0 & for x < - 1 \\ & 1 + x & for - 1 < x < 0 \\ & 1 - x & 0 < x < 1 \\ & 0 & x > 1\end{matrix} .$$

The following 64 sets of coefficients are generated where Phase (i) provides for the coefficient of a viewing pixel on a canvas position that is (i/64^{th} of a pixel) from its neighboring canvas pixel.

Phase0: 0, 128, 0, 0,

Phase1: 0, 126, 2, 0,

Phase2: 0, 124, 4, 0,

Phase3: 0, 122, 6, 0,

Phase4: 0, 120, 8, 0,

Phase5: 0, 118, 10, 0,

Phase6: 0, 116, 12, 0,

Phase7: 0, 114, 14, 0,

Phase8: 0, 112, 16, 0,

Phase9: 0, 110, 18, 0,

Phase10: 0, 108, 20, 0,

Phase11: 0, 106, 22, 0,

Phase12: 0, 104, 24, 0,

Phase13: 0, 102, 26, 0,

Phase14: 0, 100, 28, 0,

Phase15: 0, 98, 30, 0,

Phase16: 0, 96, 32, 0,

Phase17: 0, 94, 34, 0,

Phase18: 0, 92, 36, 0,

Phase19: 0, 90, 38, 0,

Phase20: 0, 88, 40, 0,

Phase21: 0, 86, 42, 0,

Phase22: 0, 84, 44, 0,

Phase23: 0, 82, 46, 0,

Phase24: 0, 80, 48, 0,

Phase25: 0, 78, 50, 0,

Phase26: 0, 76, 52, 0,

Phase27: 0, 74, 54, 0,

Phase28: 0, 72, 56, 0,

Phase29: 0, 70, 58, 0,

Phase30: 0, 68, 60, 0,

Phase31: 0, 66, 62, 0,

Phase32: 0, 64, 64, 0,

Phase33: 0, 62, 65, 0,

. . .

Phase63: 0, 2, 126, 0.

The coefficients herein listed are normalized to 128. That is the characteristics using these coefficients may have to be divided by 128 to obtain the normalized characteristics.

Other filters can also be used. For example, the catmulll-spline filter is defined as:

$$\begin{matrix}F ( x ) = & 0 & for & x < - 2 \\ & 0.5 * ( 4 + {x}^{*} ( 8 + x ( 5 + x ) ) & & - 2 < x < - 1 \\ & 0.5 * ( 2 + {x}^{*} {x}^{*} ( - 5 - 3 * x ) ) & & - 1 < x < 0 \\ & 0.5 * ( 2 + {x}^{*} {x}^{*} ( - 5 + 3 * x ) ) & & 0 < x < 1 \\ & 0.5 * ( 4 + x ( - 8 + x ( 5 - x ) ) & & 1 < x < 2 \\ & 0 & & x > 2\end{matrix}$$

As a compromise between processing time and accuracy, another preferred method uses the bicubic method of interpolation. FIG. 10a is an example of a one dimensional bicubic interpolation that estimate the viewing image at the viewing pixel “0,a” that is indicated by the darkened square as a function of the canvas image characteristics at the two canvas pixels P00 and P01 to its left and two canvas pixels to its right P02, and P03. If Chi is the horizontal (x dimension) coefficient for the ith column, then:

Pa0=Ch0*P00+Ch1*P10+Ch2*P20+Ch3*P30.

For example, if the triangular filter described above is used and the fractional part of “a” is ¼ or 4/16 away from (0,1), the coefficients from phase 16 can then be chosen such that

P0a=(0*P00+96*P10+32*P20+0*P30)/128=96*P10+32*P20.

The characteristics of the image at (0,a) using other filter coefficients or using other interpolative methods utilizing different number of canvas pixels can be similarly obtained.

Likewise, a two dimension interpolation can be obtained using a two-step one dimensional interpolation process to obtain the viewing image characteristics P(ab) at canvas position (a, b) as a function of N*M canvas pixels if those pixels are selected for filtering. For example, for a bicubic interpolation, i.e., for N=4 and M=4 where, as illustrated in FIG. 10b, the characteristics are first determined at four intermediate canvas positions (a,0), (a,1), (a,2), and (a,3) such that the image characteristics at the corresponding positions are:

P0b=Cv0*P00+Cv1*P01+Cv2*P02+Cv3*P03

P1b=Cv0*P10+Cv1*P11+Cv2*P12+Cv3*P13

P2b=Cv0*P20+Cv1*P21+Cv2*P22+Cv3*P23

P3b=Cv0*P30+Cv1*P31+Cv2*P32+Cv3*P33

Where Cvi is the vertical weighing or filtering coefficients at row “i”. These coefficients may be pre-calculated and stored in a table.

The above for image characteristics may again be combined with the corresponding Chi, the horizontal weighing or filtering coefficients at column “i” to obtain the image characteristics at (a,b) such that:

Pab=Ch0*P0b+Ch1*P1b+Ch2*P2b+Ch3*P3b

The filtering or weighing coefficients Chi and Cvi are dependent on the fractional pixel value of a and b. The size of the source image, the ratio of the sharpness/blurriness desired, and other factors may dictate the desired fractional resolution between two pixels or the fractional accuracy of the positions needed. In the preferred methods where the positions within the canvas are accurate up to 1/64 of a pixel, i.e., where the fractional resolution between two pixels is 64 steps, there may be 64 table items for each Chi or Cvi. If a tent filter is used, then these coefficients may be derived from the coefficients listed herein in this specification.

While the present invention has been described with reference to certain preferred embodiments or methods, it is to be understood that the present invention is not limited to such specific embodiments or methods. Rather, it is the inventor's contention that the invention be understood and construed in its broadest meaning as reflected by the following claims. Thus, these claims are to be understood as incorporating not only the preferred methods described herein but all those other and further alterations and modifications as would be apparent to those of ordinary skilled in the art.

We claim:

1. A method for dynamically displaying a source image on a display window of a digital display device, wherein the source image having source image characteristics, comprising the steps of:
processing the source image into a canvas image having canvas pixels as a function of the source image characteristics;
upon the canvas image meeting one or more conditions for the panning of an image, selecting a panning velocity for the canvas image;
defining a viewing window with respect to the canvas image wherein said viewing window having a viewing image, said viewing image is to have a plurality of viewing pixels;
calculating the viewing pixels for said viewing image;
displaying said viewing image for said viewing window on said display window; and
redefining said viewing window with respect to the canvas image as a function of said panning velocity

2. The method of claim 1 wherein the calculating step also includes the processing of said viewing image.

3. The method of claim 1 wherein the panning velocity having a speed of a predefined number of pixels per unit time in a predefined dimension; and wherein said redefining step redefines said viewing window the predefined number of pixels in said predefined dimension.

4. The method of claim 1 wherein
said canvas having a first dimension and a second dimension;
the panning velocity having a speed of “a” pixels per unit time in a first dimension and “b” pixels per unit time in a second dimension; and
the redefining step redefines said viewing window “a” pixels in the first defined dimension and “b” pixels in the second dimension; where “a” and “b” are fractions.

5. The method of claim 1 wherein the canvas image has canvas properties, and said panning velocity is function of the canvas properties.

6. The method of claim 1 wherein said viewing window has viewing properties, and said panning velocity is a function of said viewing properties.

7. The method of claim 1 wherein said display window having display properties, and said panning velocity is a function of said display properties.

8. The method of claim 1 wherein said panning velocity is a function of time.

9. The method of claim 1 wherein said canvas image having canvas properties, said viewing window having viewing window properties, said display window having display window properties, and said panning velocity is a function of one or more the canvas properties, the viewing properties, the display properties, and time.

10. The method of claim 1 wherein said panning velocity is nonlinear.

11. The method of claim 1 wherein said viewing image having an object and said panning velocity is a function of said object.

12. The method of claim 11 wherein said panning velocity is nonlinear.

13. The method of claim 1 wherein said calculating step comprises the substeps of:
for a viewing pixel that does not correspond to a canvas pixel, calculating that viewing pixel as a function of the canvas image characteristics from the canvas pixels surrounding that viewing pixel; and
for a viewing pixel that corresponds to a canvas pixel, calculating that viewing pixel as a function of the canvas image characteristics of the corresponding canvas pixel.

14. The method of claim 13 wherein an interpolation method is used for said calculating step.

15. The method of claim 14 wherein the interpolation method may be adaptive.

16. The method of claim 1 wherein said canvas properties include a canvas aspect ratio and said display window having a display aspect ratio, and one or more of said conditions for panning is a function of the canvas aspect ratio and the display aspect ratio.

17. The method of claim 1 wherein said canvas image having a canvas height, and said display window having a display height, and one or more of said conditions for panning is a function of said canvas height and said display height.

18. The method of claim 1 wherein said canvas having a canvas width and said display window having a display width, and one or more of said conditions for panning is a function of said canvas width and said display width.

19. The method of claim 17 wherein said canvas having a canvas width and said display window having a display width, and one or more of said conditions for panning is a function of said canvas width and said display width.

20. A method for dynamically displaying a source image on a display window of a digital display device, wherein the source image having source image characteristics, comprising the steps of:
processing the source image into a canvas image having canvas pixels as a function of the source image characteristics;
upon the canvas image meeting one or more conditions for the panning of an image, selecting a panning velocity for the canvas image, wherein the panning velocity having a speed of “a” pixels per unit time in a first dimension and “b” pixels per unit time in a second dimension;
defining a viewing window with respect to the canvas image wherein said viewing window having a viewing image, said viewing image is to have a plurality of viewing pixels;
calculating the viewing pixels for said viewing image;
displaying said viewing image for said viewing window on said display window;
redefining said viewing window with respect to the canvas image as a function of said panning velocity; and
repeating the calculating and displaying steps for said viewing window.

21. The method of claim 20 wherein the redefining step redefines said viewing window “a” pixels in the first defined dimension and “b” pixels in the second dimension; where “a” and “b” are fractions.

22. The method of claim 20 wherein said canvas image having canvas properties, said viewing window having viewing window properties, said display window having display window properties, and said panning velocity is a function of one or more the canvas properties, the viewing properties, the display properties, and time.

23. The method of claim 20 wherein said calculating step comprises the substeps of:
for a viewing pixel that does not correspond to a canvas pixel, calculating that viewing pixel as a function of the canvas image characteristics from the canvas pixels surrounding that viewing pixel; and
for a viewing pixel that corresponds to a canvas pixel, calculating that viewing pixel as a function of the canvas image characteristics of the corresponding canvas pixel.

24. The method of claim 23 wherein an adaptive interpolation method is used for said calculating step.

25. The method of claim 20 wherein said canvas properties include a canvas aspect ratio and said display window having a display aspect ratio, and one or more of said conditions for panning is a function of the canvas aspect ratio and the display aspect ratio.

26. The method of claim 20 wherein said canvas image having a canvas height, canvas width and said display window having a display height and a display width, and one or more of said conditions for panning is a function of said canvas height, canvas width, display width and said display height.

27. A method for dynamically displaying a source image on a display window of a digital display device, wherein the source image having source image characteristics, comprising the steps of:
processing the source image into a canvas image having canvas pixels as a function of the source image characteristics;
upon the canvas image meeting one or more conditions for the panning of an image, selecting a panning velocity for the canvas image, wherein the panning velocity having a speed of “a” pixels per unit time in a first dimension and “b” pixels per unit time in a second dimension;
defining a viewing window with respect to the canvas image wherein said viewing window having a viewing image, said viewing image is to have a plurality of viewing pixels;
calculating by using an adaptive method the viewing pixels for said viewing image, wherein for a viewing pixel that does not correspond to a canvas pixel, calculating that viewing pixel as a function of the canvas image characteristics from the canvas pixels surrounding that viewing pixel; and for a viewing pixel that corresponds to a canvas pixel, calculating that viewing pixel as a function of the canvas image characteristics of the corresponding canvas pixel;
displaying said viewing image for said viewing window on said display window;
redefining said viewing window with respect to the canvas image as a function of said panning velocity, wherein said viewing window is redefined “a” pixel in the first defined dimension and “b” pixel in the second dimension, where “a” and “b” are fractions; and
repeating the calculating and displaying steps for said viewing window.

28. The method of claim 27 wherein said canvas image having canvas properties, said viewing window having viewing window properties, said display window having display window properties, and said panning velocity is a function of one or more the canvas properties, the viewing properties, the display properties, time, a canvas aspect ratio, a display aspect ratio, a canvas height, a canvas width, a display width and a display height.
